(19) United States
(12) Patent Application Publication
(10) Pub. No.: US 2022/0274080 A1
(43) Pub. Date: Sep. 1, 2022

(54) METHOD FOR PREVENTING THE FLUIDIZATION OF A CATALYTIC FIXED BED IN A TUBULAR UPWARD-FLOW REACTOR OF A STEAM METHANE REFORMER

(71) Applicant: L'AIR LIQUIDE SOCIETE ANONYME POUR L'ETUDE ET L'EXPLOITATION DES PROCEDES GEORGES CLAUDE, Paris (FR)

(72) Inventors: Marie BASIN, Versailles (FR); Daniel GARY, Montigny le Bretonneux (FR); Laurent PROST, Yokohama (JP); Dieter ULBER, Steinbach (DE)

(21) Appl. No.: 17/633,059

(22) PCT Filed: Jul. 30, 2020
(86) PCT No.: PCT/EP2020/071480

§ 371 Date: Feb. 4, 2022

(30) Foreign Application Priority Data
Aug. 5, 2019 (EP) 19190074.5

(51) Int. Cl. B01J 8/06; B01J 8/00; C01B 3/38

(52) U.S. Cl. CPC B01J 8/065; B01J 8/062; B01J 8/001; C01B 3/384; B01J 2208/00548; B01J 2208/00539; B01J 2208/065; C01B 2203/0233; C01B 2203/1241; C01B 2203/1638; C01B 2203/0811

(57) ABSTRACT

The present invention relates to a method to prevent the fluidization of a catalytic fixed bed present in a tubular reactor operated in upward-flow configuration by estimating a pressure drop margin remaining before fluidization of the catalytic bed and adjusting the reactant gas flow in response. It relates also to a method to operate safely a furnace suitable for performing endothermic reactions containing a plurality of catalytic fixed bed reactors operated in upward-flow configuration, and to a method to debottleneck safely a catalytic fixed bed reactor involving a gas flowing in up flow direction.

### CROSS REFERENCE TO RELATED APPLICATIONS

This application is a 371 of International Application No. PCT/EP2020/071480, filed Jul. 30, 2020, which claims priority to European Patent Application No. 19190074.5, filed Aug. 5, 2019, the entire contents of which are incorporated herein by reference.

### BACKGROUND

The present invention relates to a method to prevent the fluidization of a catalytic fixed bed present in a tubular reactor of a furnace suitable for performing endothermic reactions with the reactant gas flowing upwardly, and to a method to operate safely a furnace suitable for performing endothermic reactions, containing a plurality of catalytic fixed bed reactors operated in upward-flow configuration by preventing the fluidization of the catalyst fixed bed present in said reactors.

Catalytic fixed bed reactors are commonly used for performing exothermic reactions like water gas shift reactions, or for performing endothermic reactions, for steam methane reforming (SMR), but also for other endothermic reactions like for example hydrocarbon feedstock cracking in externally fired reactors. Although the following description will most often refer to the SMR process, it applies as well to the other processes that utilize the same type of reactor which is operated in upward-flow configuration and which can be, —or not—, placed within a furnace.

In the context of the present invention, the terms “reactor”, “furnace”, “steam methane reformer”, “tube” and “upward-flow configuration” will be used and should be understood as hereafter defined:
a “reactor” is a vessel used to perform a chemical reaction between several reactants; when used in the context of the invention, “reactor” will refer to a particular type of reactor which is a catalytic fixed bed reactor containing solid catalysts in the form of pellets are used to carry out the chemical reaction and the catalysts are arranged in a fixed bed configuration within the vessel;
a “furnace” is an enclosed structure lined with refractory material and heated by means of burners which contains a plurality of reactors according to the previous definition;
“steam methane reformer” refers to the apparatus used to carry out the steam methane reforming reaction within a furnace as per the description above;
“tube” refers to a tubular reactor used in a steam methane reformer; it is a reactor per the above definition;
“inner tube” is an exception to the precedent definition; it refers to a tube installed in a “bayonet tube” which is used for conveying the gas produced counter currently to the reactant gas;
“upward-flow configuration” refers to an operation mode where the reactant gases are fed at the bottom of the catalytic bed and the products exit the reactor at the top of the catalytic bed.

The steam reforming process of light hydrocarbons, most often natural gas, also referred to as SMR process, is based on the reforming reaction of methane; it yields to a mixture of hydrogen and carbon oxides, mainly monoxide but also some dioxide, in the presence of water vapor. This main reaction is endothermic and slow and requires additional heat input, as well as a catalyst to occur.

In industrial practice, the steam methane reformer usually comprises tubes placed in a furnace, said tubes being filled with catalyst—most often in the form of pellets that form the catalyst bed—and fed with the reactants mixture (usually methane and steam).

FIG. 1 presents four well-proven configurations (a, b, c, d) that are currently used for furnace design with burners implemented in the furnace, either (a) on the ceiling (Top-Fired technology, also known as down-fired technology), or (b) on the floor (Up-Fired technology, also known as Bottom-Fired technology) or, on the walls (c) (Side-Fired), and (d) (Terrace-Wall technology). These furnaces are conventionally operated in downward-flow configuration, which means that the reactants are introduced at the top of the tubes and the gas produced is collected at the bottom of the tubes, such tubes will also be referred to as “conventional tubes” in the rest of the text.

In some cases however, for operating bayonet tubes for example, upward-flow operation can be more convenient.

FIG. 2 presents such a bayonet tube in upward-flow configuration. It is to be understood that in the case of bayonet tubes, the terms “upward-flow” and “downward-flow” refer to how the reactants are introduced in the catalytic bed: at the bottom for upward-flow, at the top for downward-flow. More precisely, the figure illustrates a bayonet tube in a bottom fired furnace, with the bayonet tube being placed between two burners. The gaseous mixture of reactants is introduced at the bottom of the tube and flows upward through the catalyst bed. One or more inner tubes (two on the figure) placed within the bayonet tube collect the gas produced at the top. The gas in the process of reforming and the gas reformed circulate counter-currently; the gas produced is finally collected at the bottom of the bayonet tube.

It is to be noted that bayonet tubes can be operated in a downward configuration; in that case, the reactant gas is fed at the top of the bayonet tube and the gas produced is collected as well at the top of the tube; however, the use of bayonet tubes is more convenient in upward configuration because the heavy equipment such as the product gas manifold is in that case installed on the ground and thereby the cost of the structure is significantly decreased.

This invention aims at improving the safety of catalytic fixed bed reactors being operated in upward-flow configuration.

The invention aims also at improving the safety of furnaces with at least a tube being placed within the furnace, being a conventional tube or a bayonet tube and with the burners' location being any of the locations presented in FIG. 1.

FIG. 3 presents conventional tubes in upward-flow configuration. Both FIG. 2 and FIG. 3 show burners located at the furnace floor (bottom-fired configuration) but this does not restrict the scope of the present invention that applies as well to top-fired furnace or any other furnace in upward-flow configuration.

Whatever the upward-flow technology, as the reactant stream flows from the bottom to the top of the reforming tube, the reactant gas flow rate has to be controlled in order to prevent fluidization of the catalyst bed. More precisely, the flow rate of the reactant gas has to be limited, to remain below the “minimum fluidization velocity”.

The hydrodynamics of fluidization is known and well described in the literature, for example in the Perry's Chemical Engineers' Handbook, McGraw-Hill Editions, 1999.

FIG. 4 illustrates the behaviour of a catalyst fixed bed in case fluidization of the bed occurs, i.e. when the upward Drag Force F induced by the gas flowing up through the catalyst bed is higher than the Force of Gravity W; the case of a fixed bed with the intensity of the Drag Force F being lower than the intensity of the Force of Gravity W being presented on FIG. 4a, while FIG. 4b shows the fluidization of the bed resulting from the Drag Force being higher than the Force of Gravity of the catalyst bed, with therefore a risk of destruction by attrition or grinding.

The Upward Drag Force F is the product obtained by multiplying the pressure drop, generated by the catalyst bed, by the area of the tube section crossed by the gas flowing through it (also referred to as “gas-cross-sectional area”) according to:

F=DP_{bed}×S with: (Eq.1)

F: Upward drag force of the reactant gas, in N

DP_{bed}: Pressure drop generated by the bed in Pa

S: Cross section area accessible to the gas in m².

Downward force of gravity W being the product obtained by multiplying the catalytic bed mass M_{Cat} by the constant of gravity g, it can be expressed according to:

W=M_{Cat}×g with: (Eq.2)

W: Downward force of gravity in N

M_{Cat}: Mass of the catalyst in kg

g: Gravitational Constant in m³·kg⁻¹·s⁻¹

To operate an upward-flow reactor safely, it is essential to prevent the fluidization of the catalyst fixed bed installed in the reactor. It is therefore essential to be able:
either to act against the consequences of fluidization,
or to prevent the fluidization phenomenon by keeping Drag Force below Force of Gravity.

Catalytic reactors are either fixed bed reactors or fluidized bed reactors.

Fluidized beds are well known, in the petrochemical industries for instance:
in the case thermal cracking of heavy hydrocarbons (fluid coking) to make possible the conversion of heavy residues into light cuts that are more easily recovered;
catalytic cracking of hydrocarbons (FCC) is also a process based on a circulating fluidized bed aiming at converting mixtures of aromatic hydrocarbons, paraffinic and naphthenic having a high boiling point into vapors composed of gasoline, kerosene and fractions usable in diesel engine.

Several patents disclose monitoring methods for safe operation of fluidized beds such as:
U.S. Pat. No. 4,993,264 implementing a passive acoustic process to determine the height of a fluidized bed;
U.S. Pat. No. 4,858,144 using pressure measurements at different elevations of a fluidized bed to detect abnormalities such as agglomerates of particles that can disturb the conduct of a bed used for polymerization;
U.S. Pat. No. 8,116,992 describing an apparatus and a method for determining the circulating flow rate of solids in a fluidized bed.

If usually steam methane reformers use fixed bed reactors, the problem of fluidization of the catalyst fixed bed does not exist in the case of downward-flow reactors which represent the most common design because in that case, gas flow and gravity do not conflict.

Several patents have been identified that disclose solutions to act against the consequences of operating a catalytic fixed bed when the conditions of fluidization are reached:
according to GB 1 564 994, in an apparatus for steam reforming a hydrocarbon fuel with the process fuel being passed through a tube containing the catalyst, if the catalyst filled tube is vertical and the process gas flows vertically upwardly there through, the upward force of the flowing gas is usually greater than the weight of the catalyst particles, resulting in continuous motion of the catalyst particles relative to each other. When this condition exists, the catalyst bay is said to be fluidized. The motion of the catalyst particle relative to each other is prevented, thanks to the installation of restrain means that prevent expansion of said catalytic bed beyond a predetermined volume to stop expansion of said bed prior to the onset of fluidization;
U.S. Pat. No. 990,858 A, discloses a device provided for retaining and preventing fluidization of catalyst in an up flow tubular reformer, said device being a weight installed to a conically shaped hollow member which rests at the top of the catalyst bed, with the weight functioning to prevent fluidization of the material in the tube;
U.S. Pat. No. 3,838,977 A discloses a catalytic muffler containing a catalyst bed between a perforate catalyst retainer and a movable pressure plate is provided. The pressure plate applies pressure (supplied by springs or by pneumatically actuated bellows) on the catalyst bed preventing it from becoming fluidized, preventing thus catalyst attrition; EP 1 080 772 A1 teaches that in gas separation process, adsorber fluidization can be eliminated or reduced in axial flow adsorbers for all particle size if the free adsorbant surface of the bed is constrained;
WO 00/27518 A1 discloses additional devices that when they are installed in a catalyst bed minimizes catalyst bed fluidization;
U.S. Pat. No. 4,997,465 A discloses, in a pressure swing adsorption gas concentrating system, means, including radially extensible member disposed along the container parallel to the peripheral wall and expanding means for radially maintaining the member expanded over the wide swings of pressures to provide a compressive force between the member and the peripheral wall which holds the particulate material against becoming fluidized;
U.S. Pat. No. 6,605,135 B2 discloses a system for restraining the upward motion of the granular material of containing a bed of granular material through which a fluid flows in an upward direction. The system comprises flexible porous basket within the vessel in contact with the top of the bed and the inner walls and a layer of solid bodies within the basket wherein the solid bodies press the flexible porous basket against the top of the bed.

The solutions of prior art use devices that compensate the consequences of the fluidization, and to prevent the consequences of fluidization, each reactor concerned has to be equipped with special devices.

There remains therefore a need for a method for preventing the risk of fluidization of the catalytic fixed bed in upward-flow configuration, thus enabling safe operation of said catalytic fixed bed; more precisely, there is a need for a method to prevent the fluidization phenomenon by keeping the catalyst bed away from the fluidization conditions by keeping Drag Force below Force of Gravity, without having to equip the reactor containing the catalyst bed with special devices.

There is also a need for a method to prevent the fluidization of catalyst fixed beds in a plurality of reactors installed in upward-flow furnace for catalyzed processes, and particularly for steam methane reforming.

The invention proposes to bring solution to this problem, thanks to a method that makes possible staying below the fluidization limit, without additional devices installed in the reactor, by controlling the flow rate of the reactants gas flowing into the tubes so as to remain below the minimum fluidization velocity and therefore to prevent fluidization of the catalyst in the fixed bed; it is proposed to continuously estimate a margin with respect to this minimum fluidization velocity so as to make this control feasible.

### SUMMARY

An object of the invention is a method to prevent the fluidization of a catalytic fixed bed present in a tubular reactor of a furnace suitable for performing endothermic reactions, where the reactant gas flows upwardly, characterized in that it comprises the steps of:
a) estimating a pressure drop margin remaining before fluidization of the catalytic bed,
with the pressure drop at fluidization of the catalytic bed being:

DP_{critical}=M_{cat}×g/S with
M_{cat} being the mass of the catalyst in the catalytic bed,
g being the gravitational constant,
S being the gas-cross-sectional area through which the reactant gas flows in the catalytic bed,
comprising the steps of:
   i) calculating the pressure drop at fluidization of the catalyst bed DP_{critical},
   ii) measuring the pressure drop DP_{bed} between the top and the bottom of the catalytic bed,
   iii) determining a pressure drop margin before fluidization,
b) adjusting the reactant gas flow in response to the pressure drop margin.

Some variants of the method according to the invention are presented hereafter; they may be considered alone or in combination:
DP_{bed} can be measured by means of a Differential Pressure Transmitter (DPT);
DP_{bed} can be measured by means of two Pressure Transmitter (PT), one installed at the catalytic bed inlet and the other installed at the outlet of the catalytic bed, and the pressure drop is calculated in the Distributed Control System (DCS) which operates the overall plant to which the reactor belongs;
the pressure drop margin may be expressed so as to give the consumed margin, preferably as (DP_{bed}/DP_{critical})×100;
the pressure drop margin may be expressed so as to indicate the remaining margin before fluidization, preferably as (1−DP_{bed}/DP_{critical})×100;
the pressure drop margin is expressed so as to give the consumed margin, preferably as (DP_{bed}/DP_{critical})×100, this consumed margin is controlled so as to remain below 90%, preferably below 80% by adjusting the reactants gas flow;
the pressure drop margin is expressed so as to give the remaining margin before fluidization, preferably as (1−DP_{bed}/DP_{critical})×100, this remaining margin is controlled so as to stay above 10%, preferably above 20% by adjusting the reactants gas flow.

According to another object of the invention, it relates to a method to operate safely a furnace suitable for performing endothermic reactions, containing a plurality of catalytic fixed bed reactors operated in upward-flow configuration characterized in that it comprises the prevention of the fluidization of the catalyst fixed bed present in said reactors by applying any of the methods above to at least one of said reactors; the furnace may be a steam methane reformer furnace.

According to still another object of the invention, it relates to a method to debottleneck safely a catalytic fixed bed present in a tubular reactor of a furnace suitable for performing endothermic reactions, with the reactant gas flowing upwardly, where the method includes increasing the reactant gas flow in the reactor characterized in that the risk of fluidization of the catalyst bed present in the reactor is simultaneously prevented by applying any of the methods above.

### BRIEF DESCRIPTION OF THE DRAWINGS

The invention and its advantages will be described in more details in the following examples and on the basis of the drawings, where:

FIG. 1 shows the four main configurations of the industrial practice for the steam methane reforming;

FIG. 2 shows a bayonet tube in a bottom-fired furnace, in an upward-flow configuration, suitable for the implementation of the invention;

FIG. 3 shows two conventional tubes in an upward-flow configuration, suitable for the implementation of the invention;

FIG. 4 shows schematically the behaviour of a catalyst fixed bed submitted to the force of gravity and the drag force induced by gas flowing up through the catalyst bed;

FIG. 5 shows an example of application of the invention applied to a conventional tube similar to the tubes of FIG. 3;

FIG. 6 shows an example of application of the invention applied to a bayonet tube similar to the tubes of FIG. 2.

### DETAILED DESCRIPTION OF THE PREFERRED EMBODIMENTS

Reading the following more detailed description of the figures will help understanding the invention. Note that in the figures, analogous items (either apparatus or process step) are identified by reference numerals identical except for the left digit, which refers to the number of the figure.

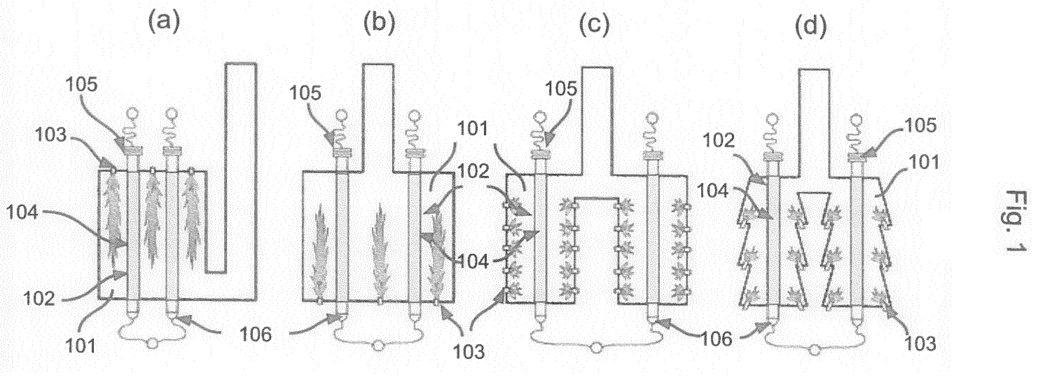

FIG. 1 shows schematically four conventional designs where a furnace 101 contains tubes 102 heated by burners 103. Reactant gas 105 are introduced at the top of the tubes and flow down through the catalyst bed 104 installed in the tubes for the reforming of the reactant gas, and the product gas 106 leave the tube at the bottom end, opposite to the entrance.

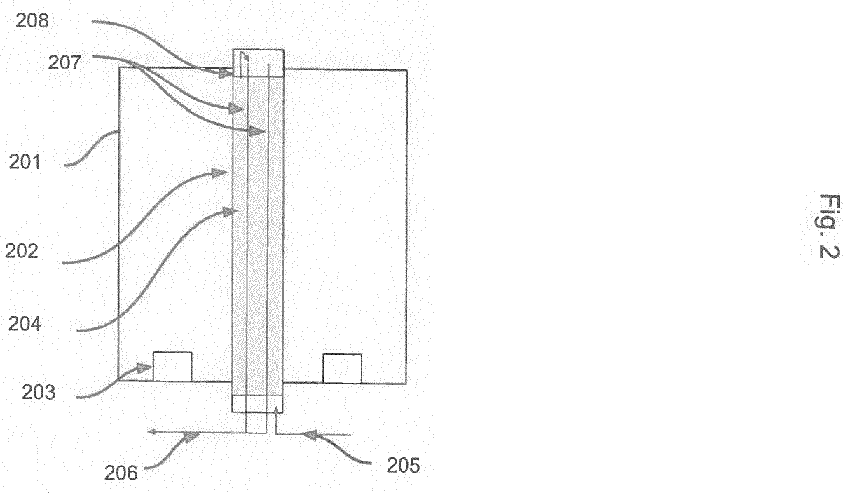

In FIG. 2, the tube 202 presented is a bayonet tube; installed in the furnace 201, the tube is heated by burners 203 mounted at the floor of the furnace. A bayonet tube is composed of one external tube where the reforming takes place and one or more internal tubes installed in the catalyst bed for the transportation of the hot gas produced gas. The reactant gas 205 is introduced in the catalytic bed 204 (the catalytic bed appears in grey in this figure and in the other figures as well) at the bottom of the tube (upward-flow). Two inner tubes 207 are placed within the tubes 202 of the furnace 201. The reactants 205 are introduced at the bottom of the catalytic bed 204. The upper end of the tube 202 is a closed end; therefore, above the end of the catalytic bed, at a location identified as “reverse point” 208, the product gas is forced to enter into the inner tubes 207 and to flow counter-currently to the reactant gas. The product gas 206 then exits the tube at the same end where the reactant gas 205 is introduced in the tube 202. The upward-flow configuration coupled to the use of bayonet tubes as presented on the figure allows advantageously to install heavy equipment like the product gas manifold on the ground and thereby decreases in an important manner the cost of the furnace structure.

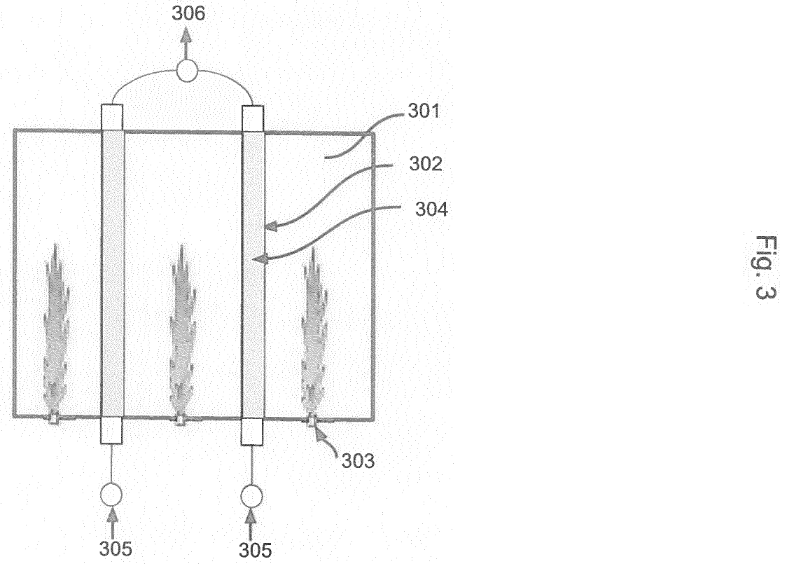

FIG. 3 presents conventional tubes 302 in an upward-flow configuration; tubes are installed in the furnace 301 and are heated by burners 303 mounted at the bottom of the furnace. The reactant gas 305 is fed at the bottom of the tubes filled with catalyst 304 and the gas produced 306 is collected at the top of the tubes.

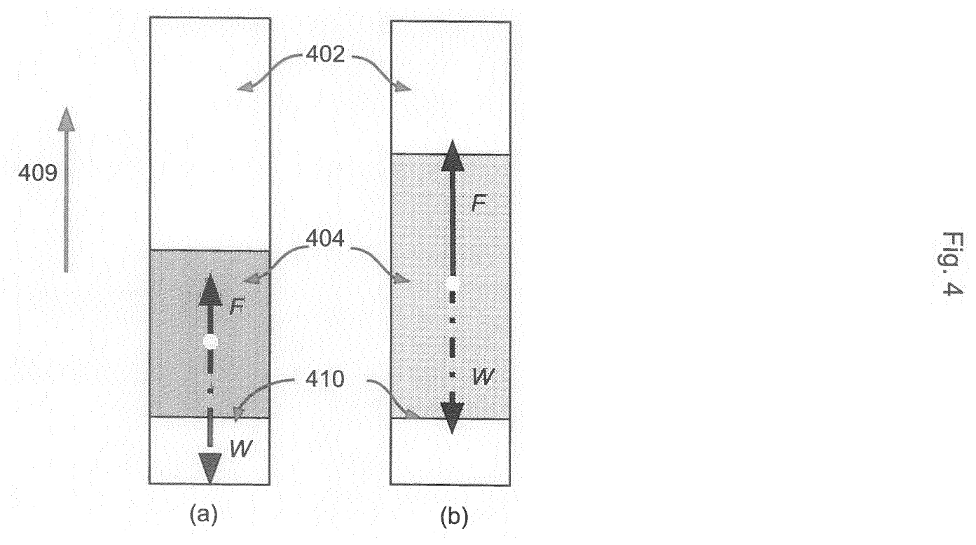

FIG. 4, as already explained above, presents the forces F and W acting on the catalyst fixed bed 404 which can initiate the phenomenon of fluidization if the upward drag force F induced by the gas flowing up through the catalyst bed (the direction of the flow is represented by arrow 409) is higher than the force of gravity W; FIG. 4(a) illustrates the case of a fixed bed 404 with the intensity of the Drag Force F being lower than the intensity of the Force of Gravity W, FIG. 4(b) shows the fluidization of the bed resulting from the intensity of the Drag Force F induced by the gas flow rate being higher than the intensity of the Force of Gravity W of the catalyst bed, with a risk of destruction by attrition or grinding. By construction, a support 410 is of course present at the bottom of the bed to maintain it in place.

Thanks to the present invention, simple method and apparatus are proposed to monitor and control the operation of an upward-flow reactor to remain below the fluidization limit. From the fluidization theory as exposed above, the pressure drop at fluidization DP_{critical} (which is the pressure drop value corresponding to fluidization limit, i.e. when the Drag Force F is equal to the Force of Gravity W) is easily calculated from Eq.1=Eq.2, leading to:

DP_{critical}=M_{cat}×g/S with: (Eq.3)

g is the gravitational constant;

S is the gas-cross-sectional area through which the reactant gas flows in the tube, its value is calculated from the tube dimensions;

M_{cat} can be estimated from the data coming from the loading operations (the average mass M_{Cat} of the catalyst filled in tubes during the loading operation is recorded). It appears thus from the above that this pressure drop at fluidization DP_{critical} is independent of the operating conditions.

DP_{bed} can be immediately obtained from simple measurements.

By making said measurements continuously—for example by installing a Differential Pressure Sensor/Transmitter (DPT) that will give an on-line and continuous access to the pressure drop of the catalytic bed DP_{bed}—and as the pressure drop at fluidization DP_{critical} is known, the margin between the actual pressure drop DP_{bed} and the critical one DP_{critical} is easily monitored.

The choice of the DPT and its installation have to be made carefully to ensure that:
the sensor technology will not generate pressure drop and disturb the gas stream flow;
there is no other equipment installed between the pressure taps located upstream and downstream that could generate a pressure drop.

Implementing a critical margin monitoring method in the Distributed Control System (DCS) of the plant is easy; the monitoring criterion will depend on DP_{Bed} which is measured and DP_{Critical}, which is calculated according to Eq.3.

This criterion can be expressed by different ways, for instance:
it can be expressed as (DP_{bed}/DP_{critical})×100 according to Eq.4; In that case, it is representative of the percentage of the margin that is consumed: when this criterion is equal to 100%, it means that the margin is fully consumed; the critical load is reached, the load of the plant cannot be increased without inducing a risk of fluidization of the catalyst fixed bed;
alternatively, by expressing the criterion as (1−[DP_{Bed}/DP_{Critical}])×100) according to Eq.5, it is representative of the percentage of remaining margin before reaching the critical load of the plant;
other expressions can of course be imagined for this criterion while remaining within the scope of the invention.

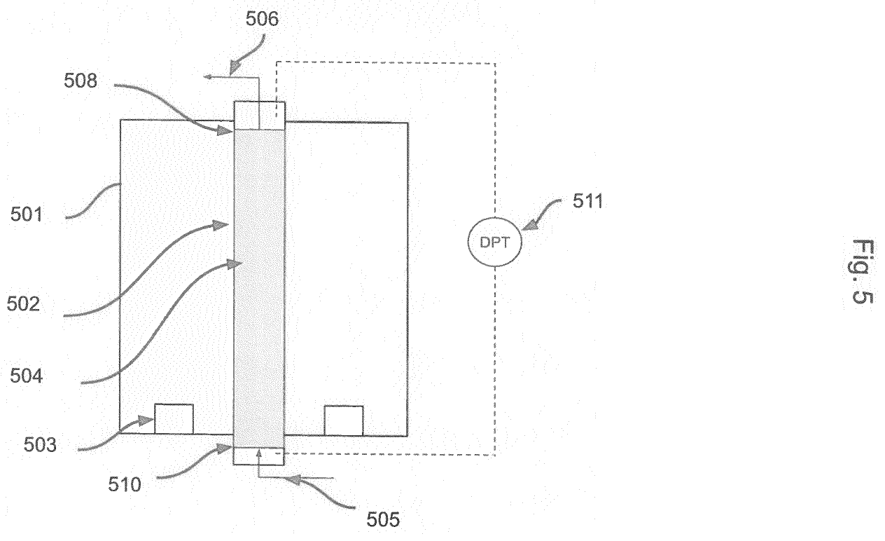

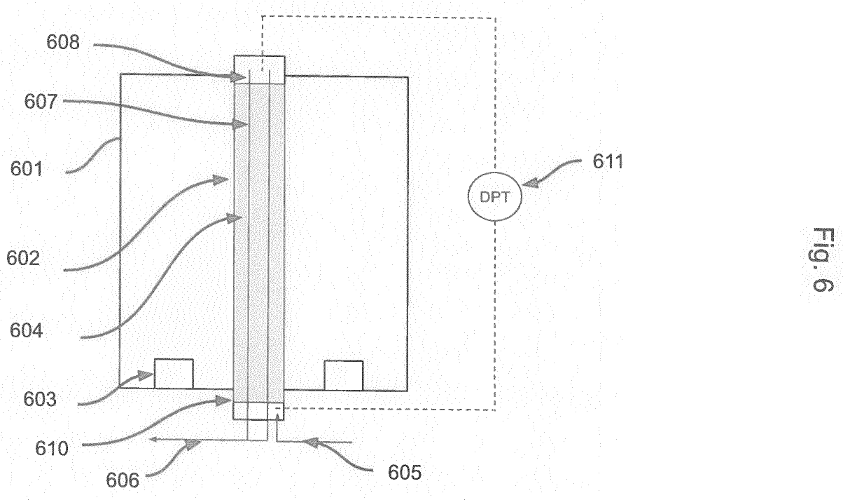

Two examples of application of the invention are presented hereafter in relation with FIG. 5 and FIG. 6. They illustrate the present invention, but must not be considered as limiting its scope of application.

### Examples

Example 1 is based on the design of the tube of FIG. 5, which is itself a conventional tube similar to the tube of FIG. 4. The tube 502 is a conventional tube installed in a bottom-fired furnace 501. The reactants 505 are introduced at the bottom the tube, at the inlet of the catalytic bed 504, the product gas mixture 506 is collected at the outlet of the catalytic bed, at the top of the tube. The burners 503 are placed at the furnace floor. To implement the invention, a differential pressure sensor 511 equipped with a transmitter (referred as DPT) is installed to measure the pressure drop DP_{bed} between the catalytic bed inlet 510 and the catalytic bed outlet 508.

The tube 502 is filled with 100 kg of catalyst, it has an inner diameter of 0.1 m.
pressure drop at fluidization is calculated by applying Eq.3: DP_{Critical}=M_{Cat}×g/S:

DP_{Critical}=100×9.81/(3.14×(0.1/2)²)=1.25·10⁵ Pa. (i.e. 1.25 bar).
DP_{bed} is given by the DPT.
The criterion defining the margin remaining left between DP_{bed} and DP_{Critical} is calculated either by applying Eq.4 or Eq.5; assuming that DP_{b}ea as measured by the DPT is 1 bar, then it means that according to Eq.4, 80% of the margin is consumed; expressed otherwise according to Eq.5, the margin remaining before fluidization is 20%.

Example 2 is based on the design of the tube of FIG. 6 which presents a bayonet tube 602 installed in a bottom-fired furnace 601, the reactants 605 are introduced at the inlet 610 of the catalytic bed 604—at the bottom of the tube—and, at the outlet of the catalytic bed 608—also known as reverse point—, the gas produced 606 enters the inner tubes 607 and is then collected at the bottom end of the tube 602. The burners 603 are placed at the furnace floor. To implement the invention, a differential pressure sensor equipped with a transmitter (referred as DPT) 611 is installed to measure the pressure drop DP_{bed} between the catalytic bed inlet and the reverse point 608.

The tube 602 has an inner diameter of 0.125 m, it contains two inner tubes 607 having an outer diameter of 0.025 m. The tube 602 is filled with 95 kg of catalyst.
pressure drop at fluidization is calculated by applying Eq.3: DP_{Critical}=M_{Cat}×g/S; in that case, it is necessary to take into account the 2 inner tubes and to remove their section for the calculation of S, which leads to S=3.14×(0.125/2)²−2×3.14×(0.025/2)²; the pressure drop at fluidization is therefore: DP_{Critical}=M_{Cat}×g/S=95×9.81/((3.14×(0.125/2)²−2×3.14×(0.025/2)²)=8.25·10⁴ Pa. (i.e. 0.825 bar).
DP_{bed} is given by the DPT.
The criterion defining the margin remaining left between DP_{bed} and DP_{Critical} is calculated either by applying Eq.4 or Eq.5; assuming that DP_{bed} as measured by the DPT is 0.6 bar, then it means that according to Eq.4, 73% of the margin is consumed; expressed otherwise according to Eq.5, the margin remaining before fluidization is 27%.

Thereby, based on the method set forth above, the operator can permanently know the actual fluidization margin of the plant. This information is of prime importance when a the plant is operated at a higher load than its nominal capacity to meet a customer's need for more hydrogen.

Steam reformers and other externally fired reactors can contain from ten to several hundred of tubes filled with catalyst. The filling procedures are well established and can lead to a small variation of the amount of catalyst in each tube. This variation is usually kept below +/−5% and recorded during the filling procedure. Thus, the operator knows which tube contains the lowest amount of catalyst and can use this lowest amount in the fluidization margin calculation. In operation, the feed gas flow will be distributed amongst the tubes so that the pressure drop is the same in all tubes; therefore equipping only one tube with pressure sensors may be enough in theory.

In practice, it might be advantageous to equip several tubes. Indeed, if only one tube is equipped and there is a sensor failure due to breakage, dust or water clogging, then the information is lost whereas if sensors are installed on several tubes, then the system is more reliable. In the case of a single reactor, it might be advantageous to install several sensors to prevent any information loss in case of breakage, dust or water clogging.

As this monitoring method is easy to implement, reliable and low cost, it will be possible to select and equip the tubes being filled with the lowest amount of catalyst for example, or to select and equip tubes in different rows and according to their position in a row (i.e. at the beginning, the middle or the end), or any other selection based on specific behaviour of certain tubes in the furnace.

The method can be implemented in a plant when a debottlenecking is scheduled in order to control the reactants gas flow so as to prevent the risk of fluidization.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-8. (canceled)

9. A method to prevent the fluidization of a catalytic fixed bed present in a tubular reactor of a furnace suitable for performing endothermic reactions, where the reactant gas flows upwardly, comprising:
a) estimating a pressure drop margin remaining before fluidization of the catalytic bed,
with the pressure drop at fluidization of the catalytic bed being:
DP_{critical}=M_{cat}×g/S with
M_{cat} being the mass of the catalyst in the catalytic bed,
g being the gravitational constant,
S being the gas-cross-sectional area through which the reactant gas flows in the catalytic bed,
comprising:
i) calculating the pressure drop at fluidization of the catalyst bed,
ii) measuring the pressure drop DP_{bed} between the top and the bottom of the catalytic bed,
iii) determining a pressure drop margin before fluidization,
b) adjusting the reactant gas flow in response to the pressure drop margin.

10. The method according to claim 9 where DP_{bed} is measured by means of a Differential Pressure Transmitter.

11. The method according to claim 9 where DP_{bed} is measured by means of two Pressure Transmitter, one installed at the catalytic bed inlet and the other installed at the catalytic bed outlet, and the pressure drop is calculated in the plant Distributed Control System.

12. The method according to claim 9, wherein the pressure drop margin before fluidization is expressed as a consumed margin, defined as the percentage (DP_{bed}/DP_{critical})×100, the reactant gas flow being adjusted to keep the consumed margin below 90%.

13. The method according to claim 9, wherein the pressure drop margin is expressed so as to give a remaining margin before fluidization, defined as the percentage (1−DP_{bed}/DP_{critical})×100, the reactant gas flow being adjusted to keep the reactant margin above 10%.

14. A method to operate safely a furnace suitable for performing endothermic reactions, containing a plurality of catalytic fixed bed reactors operated in upward-flow configuration comprising the prevention of the fluidization of the catalyst fixed bed present in said reactors by applying the method of claim 9 to at least one of said reactors.

15. The method according to claim 14, wherein the furnace is a steam methane reformer furnace.

16. A method to debottleneck safely a catalytic fixed bed present in a tubular reactor of a furnace suitable for performing endothermic reactions, with the reactant gas flowing upwardly, where the method includes increasing the reactant gas flow in the reactor characterized in that the risk of fluidization of the catalyst bed present in the reactor is simultaneously prevented by applying the method of claim 9.
